(19) United States
(12) Patent Application Publication
(10) Pub. No.: US 2016/0121348 A1
(43) Pub. Date: May 5, 2016

(54) PROVIDING A SCENT WHILE A USER INTERACTS WITH AN ELECTRONIC MEDIA PROVIDING DEVICE

(71) Applicant: Kobo Incorporated, Toronto (CA)

(72) Inventor: Stanley Xiaodong LIU, Toronto (CA)

(73) Assignee: Kobo Incorporated, Toronto (CA)

(21) Appl. No.: 14/533,890

(22) Filed: Nov. 5, 2014

(51) Int. Cl. B05B 9/01; G06F 17/30; G06F 3/0483; A63F 13/28; A63F 13/70

(52) U.S. Cl. CPC B05B 9/01; A63F 13/28; A63F 13/70; G06F 3/0483; G06F 17/30598

(57) ABSTRACT

A request to open electronic media on the electronic media providing device is detected. A scent is sprayed in response to the detecting of the request to open the electronic media.

### TECHNICAL FIELD

Examples described herein relate to a system and method for providing a scent while a user interacts with an electronic media providing device.

### BACKGROUND

An electronic personal display is a mobile computing device that displays information to a user. While an electronic personal display may be capable of many of the functions of a personal computer, a user can typically interact directly with an electronic personal display without the use of a keyboard that is separate from or coupled to but distinct from the electronic personal display itself. Some examples of electronic personal displays include mobile digital devices/tablet computers and electronic readers (e-readers) such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, Kobo Aura H2O and the like).

Some electronic personal display devices are purpose built devices designed to perform especially well at displaying digitally-stored content for reading or viewing thereon. For example, a purpose build device may include a display that reduces glare, performs well in high lighting conditions, and/or mimics the look of text as presented via actual discrete pages of paper. While such purpose built devices may excel at displaying content for a user to read, they may also perform other functions, such as displaying images, emitting audio, recording audio, and web surfing, among others.

There are also numerous kinds of consumer devices that can receive services and resources from a network service. Such devices can operate applications or provide other functionality that links a device to a particular account of a specific service. For example, the electronic reader (e-reader) devices typically link to an online bookstore, and media playback devices often include applications that enable the user to access an online media electronic library (or e-library). In this context, the user accounts can enable the user to receive the full benefit and functionality of the device.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 illustrates a system utilizing applications and providing e-book services on a computing device for transitioning to an alternate mode of operation, according to an embodiment.

FIG. 2 illustrates an example architecture of a computing device for transitioning to an alternate mode of operation, according to an embodiment.

FIG. 3 illustrates a method of operating a computing device for transitioning to an alternate mode of operation, according to an embodiment.

FIG. 4 depicts a block diagram of a system for providing a scent while a user interacts with an electronic media providing device, according to one embodiment.

FIG. 5 depicts a flowchart for a method of providing a scent while a user interacts with an electronic media providing device, according to one embodiment.

### DESCRIPTION OF EMBODIMENTS

Unless specifically stated otherwise as apparent from the following discussions, it is appreciated that throughout the present Description of Embodiments, discussions utilizing terms such as “detecting,” “spraying,” “associating,” “determining,” “selecting,” “providing,” or the like, often refer to the actions and processes of an electronic computing device/system, such as an electronic media providing device, electronic reader (“eReader”), computer system, and/or a mobile (i.e., handheld) multimedia device, among others. The electronic computing device/system manipulates and transforms data represented as physical (electronic) quantities within the circuits, electronic registers, memories, logic, and/or components and the like of the electronic computing device/system into other data similarly represented as physical quantities within the electronic computing device/system or other electronic computing devices/systems.

Embodiments described herein provide for a computing device that is operable even when water and/or other persistent objects are present on the surface of a display of the computing device. More specifically, the computing device may detect a presence of extraneous objects (e.g., such as water, dirt, or debris) on a surface of the display screen, and perform one or more operations to mitigate or overcome the presence of such extraneous objects in order to maintain a functionality for use as intended, and/or viewability of content displayed on the display screen. For example, upon detecting the presence of one or more extraneous objects, such as water droplets, debris or dirt, certain settings or configurations of the computing device may be automatically adjusted, thereby invoking operation via an alternate user interface mode, whereby gestures may be dissociated from recognition as valid user input commands to perform a given processor output operation, and instead, an alternate user input scheme becomes associated with performance of said processor output operation.

Electronic books (also known as “E-books”) and electronic games are in a form of electronic publication content stored in digital format in a computer non-transitory memory, viewable on a computing device with suitable functionality. An e-book can correspond to, or mimic, the paginated format of a printed publication for viewing, such as provided by printed literary works (e.g., novels) and periodicals (e.g., magazines, comic books, journals, etc.). Optionally, some e-books may have chapter designations, as well as content that corresponds to graphics or images (e.g., such as in the case of magazines or comic books). Multi-function devices, such as cellular-telephony or messaging devices, can utilize specialized applications (e.g., specialized e-reading application software) to view e-books in a format that mimics the paginated printed publication. Still further, some devices (sometimes labeled as “e-readers”) can display digitally-stored content in a more reading-centric manner, while also providing, via a user input interface, the ability to manipulate that content for viewing, such as via discrete successive pages.

An “electronic media providing device,” also referred to herein as an electronic personal display, can refer to any computing device that can display or otherwise render an e-book or games. According to one embodiment, the electronic media providing device is an “e-reading device” that is used for rendering e-books. Although many embodiments are described in the context of an e-reading device, an electronic media providing device can have all or a subset of the functionality of an e-reading device.

By way of example, an electronic media providing device can include a mobile computing device on which an e-reading application can be executed to render content that includes e-books (e.g., comic books, magazines, etc.). Such mobile computing devices can include, for example, a multi-functional computing device for cellular telephony/messaging (e.g., feature phone or smart phone), a tablet computer device, an ultramobile computing device, or a wearable computing device with a form factor of a wearable accessory device (e.g., smart watch or bracelet, glasswear integrated with a computing device, etc.). As another example, an e-reading device can include an e-reader device, such as a purpose-built device that is optimized for an e-reading experience (e.g., with E-ink displays). In another example, the mobile computing device may include an application for rendering content for a game.

One or more embodiments described herein provide that methods, techniques and actions performed by a computing device are performed programmatically, or as a computer-implemented method. Programmatically means through the use of code or computer-executable instructions. A programmatically performed step may or may not be automatic.

One or more embodiments described herein may be implemented using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer programs, or a computer usable carrier medium capable of carrying such a program.

### Overview of Discussion for Providing a Scent while a User is Interacting with an Electronic Media Providing Device

Various embodiments provide a scent while a user is interacting with an electronic media providing device 400B. Examples of media are electronic games and electronic books. Examples of an electronic media providing device 400B are mobile digital devices/tablet computers and electronic readers (e-readers) such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, Kobo Aura H2O and the like). According to one embodiment, a request to open media on the electronic media providing device 400B is detected and a scent is sprayed in response to the detecting of the request to open the media.

### System and Hardware Description

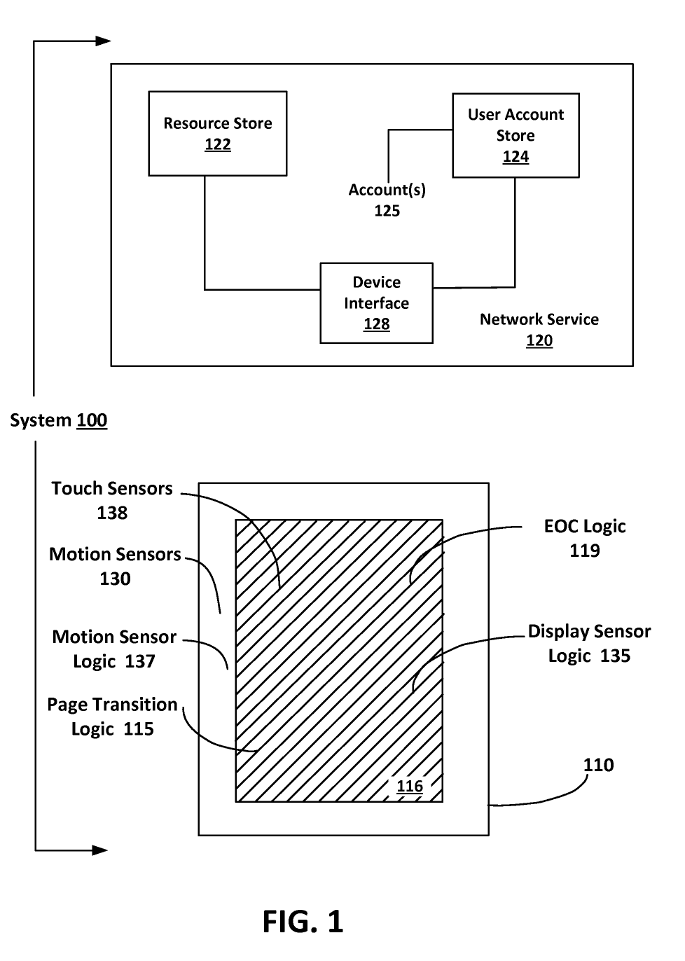

FIG. 1 illustrates a system 100 for utilizing applications and providing e-book services on a computing device, according to an embodiment. In an example of FIG. 1, system 100 includes an electronic personal display device, shown by way of example as an e-reading device 110, and a network service 120. The network service 120 can include multiple servers and other computing resources that provide various services in connection with one or more applications that are installed on the e-reading device 110. By way of example, in one implementation, the network service 120 can provide e-book services which communicate with the e-reading device 110. The e-book services provided through network service 120 can, for example, include services in which e-books are sold, shared, downloaded and/or stored. More generally, the network service 120 can provide various other content services, including content rendering services (e.g., streaming media) or other network-application environments or services.

The e-reading device 110 can correspond to any electronic personal display device on which applications and application resources (e.g., e-books, media files, documents) can be rendered and consumed. For example, the e-reading device 110 can correspond to a tablet or a telephony/messaging device (e.g., smart phone). In one implementation, for example, e-reading device 110 can run an e-reader application that links the device to the network service 120 and enables e-books provided through the service to be viewed and consumed. In another implementation, the e-reading device 110 can run a media playback or streaming application that receives files or streaming data from the network service 120. By way of example, the e-reading device 110 can be equipped with hardware and software to optimize certain application activities, such as reading electronic content (e.g., e-books). For example, the e-reading device 110 can have a tablet-like form factor, although variations are possible. In some cases, the e-reading device 110 can also have an E-ink display.

In additional detail, the network service 120 can include a device interface 128, a resource store 122 and a user account store 124. The user account store 124 can associate the e-reading device 110 with a user and with an account 125. The account 125 can also be associated with one or more application resources (e.g., e-books), which can be stored in the resource store 122. The device interface 128 can handle requests from the e-reading device 110, and further interface the requests of the device with services and functionality of the network service 120. The device interface 128 can utilize information provided with a user account 125 in order to enable services, such as purchasing downloads or determining what e-books and content items are associated with the user device. Additionally, the device interface 128 can provide the e-reading device 110 with access to the content store 122, which can include, for example, an online store. The device interface 128 can handle input to identify content items (e.g., e-books), and further to link content items to the account 125 of the user.

As described further, the user account store 124 can retain metadata for individual accounts 125 to identify resources that have been purchased or made available for consumption for a given account. The e-reading device 110 may be associated with the user account 125, and multiple devices may be associated with the same account. As described in greater detail below, the e-reading device 110 can store resources (e.g., e-books) that are purchased or otherwise made available to the user of the e-reading device 110, as well as to archive e-books and other digital content items that have been purchased for the user account 125, but are not stored on the particular computing device.

With reference to an example of FIG. 1, e-reading device 110 can include a display screen 116. In an embodiment, the display screen 116 is touch-sensitive, to process touch inputs including gestures (e.g., swipes). For example, the display screen 116 may be integrated with one or more touch sensors 138 to provide a touch sensing region on a surface of the display screen 116. For some embodiments, the one or more touch sensors 138 may include capacitive sensors that can sense or detect a human body's capacitance as input. In the example of FIG. 1, the touch sensing region coincides with a substantial surface area, if not all, of the display screen 116. Additionally, the housing can also be integrated with touch sensors to provide one or more touch sensing regions, for example, could be on the bezel and/or back surface of the housing.

In some embodiments, the e-reading device 110 includes features for providing functionality related to displaying paginated content. The e-reading device 110 can include page transitioning logic 115, which enables the user to transition through paginated content. The e-reading device 110 can display pages from e-books, and enable the user to transition from one page state to another. In particular, an e-book can provide content that is rendered sequentially in pages, and the e-book can display page states in the form of single pages, multiple pages or portions thereof. Accordingly, a given page state can coincide with, for example, a single page, or two or more pages displayed at once. The page transitioning logic 115 can operate to enable the user to transition from a given page state to another page state. In some implementations, the page transitioning logic 115 enables single page transitions, chapter transitions, or cluster transitions (multiple pages at one time).

The page transitioning logic 115 can be responsive to various kinds of interfaces and actions in order to enable page transitioning. In one implementation, the user can signal a page transition event to transition page states by, for example, interacting with the touch sensing region of the display screen 116. For example, the user may swipe the surface of the display screen 116 in a particular direction (e.g., up, down, left, or right) to indicate a sequential direction of a page transition. In variations, the user can specify different kinds of page transitioning input (e.g., single page turns, multiple page turns, chapter turns, etc.) through different kinds of input. Additionally, the page turn input of the user can be provided with a magnitude to indicate a magnitude (e.g., number of pages) in the transition of the page state. For example, a user can touch and hold the surface of the display screen 116 in order to cause a cluster or chapter page state transition, while a tap in the same region can effect a single page state transition (e.g., from one page to the next in sequence). In another example, a user can specify page turns of different kinds or magnitudes through single taps, sequenced taps or patterned taps on the touch sensing region of the display screen 116.

E-reading device 110 can also include one or more motion sensors 136 arranged to detect motion imparted thereto, such as by a user while reading or in accessing associated functionality. In general, the motion sensor(s) 136 may be selected from one or more of a number of motion recognition sensors, such as but not limited to, an accelerometer, a magnetometer, a gyroscope and a camera. Further still, motion sensor 136 may incorporate or apply some combination of the latter motion recognition sensors.

In an accelerometer-based embodiment of motion sensor 135, when an accelerometer experiences acceleration, a mass is displaced to the point that a spring is able to accelerate the mass at the same rate as the casing. The displacement is then measured thereby determining the acceleration. In one embodiment, piezoelectric, piezoresistive and capacitive components are used to convert the mechanical motion into an electrical signal. For example, piezoelectric accelerometers are useful for upper frequency and high temperature ranges. In contrast, piezoresistive accelerometers are valuable in higher shock applications. Capacitive accelerometers use a silicon micro-machined sensing element and perform well in low frequency ranges. In another embodiment, the accelerometer may be a micro electro-mechanical systems (MEMS) consisting of a cantilever beam with a seismic mass.

In an alternate embodiment of motion sensor 136, a magnetometer, such as a magnetoresistive permalloy sensor can be used as a compass. For example, using a three-axis magnetometer allows a detection of a change in direction regardless of the way the device is oriented. That is, the three-axis magnetometer is not sensitive to the way it is oriented as it will provide a compass type heading regardless of the device's orientation.

In another embodiment of motion sensor 136, a gyroscope measures or maintains orientation based on the principles of angular momentum. In one embodiment, the combination of a gyroscope and an accelerometer comprising motion sensor 135 provides more robust direction and motion sensing.

In yet another embodiment of motion sensor 136, a camera can be used to provide egomotion, e.g., recognition of the 3D motion of the camera based on changes in the images captured by the camera. In one embodiment, the process of estimating a camera's motion within an environment involves the use of visual odometry techniques on a sequence of images captured by the moving camera. In one embodiment, it is done using feature detection to construct an optical flow from two image frames in a sequence. For example, features are detected in the first frame, and then matched in the second frame. The information is then used to make the optical flow field showing features diverging from a single point, e.g., the focus of expansion. The focus of expansion indicates the direction of the motion of the camera. Other methods of extracting egomotion information from images, method that avoid feature detection and optical flow fields are also contemplated. Such methods include using the image intensities for comparison and the like.

According to some embodiments, the e-reading device 110 includes display sensor logic 135 to detect and interpret user input or user input commands made through interaction with the touch sensors 138. By way of example, the display sensor logic 135 can detect a user making contact with the touch sensing region of the display screen 116. More specifically, the display sensor logic 135 can detect taps, an initial tap held in sustained contact or proximity with display screen 116 (otherwise known as a “long press”), multiple taps, and/or swiping gesture actions made through user interaction with the touch sensing region of the display screen 116. Furthermore, the display sensor logic 135 can interpret such interactions in a variety of ways. For example, each interaction may be interpreted as a particular type of user input corresponding with a change in state of the display 116.

For some embodiments, the display sensor logic 135 may further detect the presence of water, dirt, debris, and/or other extraneous objects on the surface of the display 116. For example, the display sensor logic 135 may be integrated with a water-sensitive switch (e.g., such as an optical rain sensor) to detect an accumulation of water on the surface of the display 116. In a particular embodiment, the display sensor logic 135 may interpret simultaneous contact with multiple touch sensors 138 as a type of non-user input. For example, the multi-sensor contact may be provided, in part, by water and/or other unwanted or extraneous objects (e.g., dirt, debris, etc.) interacting with the touch sensors 138. Specifically, the e-reading device 110 may then determine, based on the multi-sensor contact, that at least a portion of the multi-sensor contact is attributable to presence of water and/or other extraneous objects on the surface of the display 116.

E-reading device 110 further includes motion gesture logic 137 to interpret user input motions as commands based on detection of the input motions by motion sensor(s) 136. For example, input motions performed on e-reading device 110 such as a tilt, a shake, a rotation, a swivel or partial rotation and an inversion may be detected via motion sensors 136 and interpreted as respective commands by motion gesture logic 137.

E-reading device 110 further includes extraneous object configuration (EOC) logic 119 to adjust one or more settings of the e-reading device 110 to account for the presence of water and/or other extraneous objects being in contact with the display screen 116. For example, upon detecting the presence of water and/or other extraneous objects on the surface of the display screen 116, the EOC logic 119 may power off the e-reading device 110 to prevent malfunctioning and/or damage to the device 110. EOC logic 119 may then reconfigure the e-reading device 110 by invalidating or dissociating a touch screen gesture from being interpreted as a valid input command, and in lieu thereof, associate an alternative type of user interactions as valid input commands, e.g., motion inputs that are detected via the motion sensor(s) 136 will now be associated with any given input command previously enacted via the touch sensors 138 and display sensor logic 135. This enables a user to continue operating the e-reading device 110 even with the water and/or other extraneous objects present on the surface of the display screen 116, albeit by using the alternate type of user interaction.

In some embodiments, input motions performed on e-reading device 110, including but not limited to a tilt, a shake, a rotation, a swivel or partial rotation and an inversion may be detected via motion sensors 136 and interpreted by motion gesture logic 137 to accomplish respective output operations for e-reading actions, such as turning a page (whether advancing or backwards), placing a bookmark on a given page or page portion, placing the e-reader device in a sleep state, a power-on state or a power-off state, and navigating from the e-book being read to access and display an e-library collection of e-books that may be associated with user account store 124.

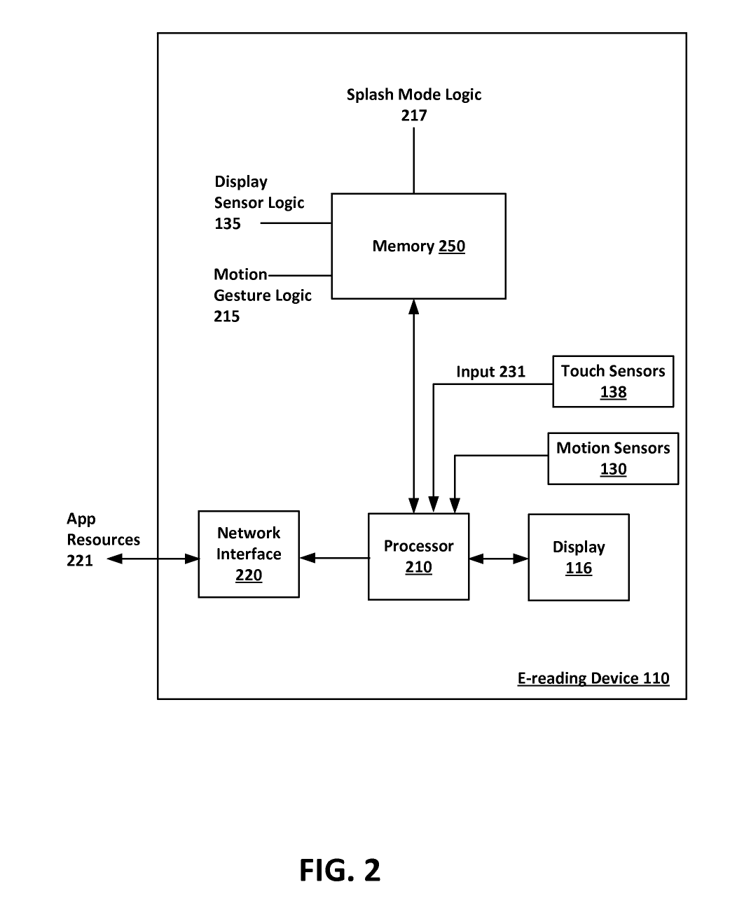

FIG. 2 illustrates an architecture, in one embodiment, of e-reading device 110 as described above with respect to FIG. 1. With reference to FIG. 2, e-reading device 110 further includes a hardware processor 210, hardware memory 250 storing instructions and logic pertaining at least to display sensor logic 135, extraneous object logic 119 and motion gesture logic 137.

The processor 210 can implement functionality using the logic and instructions stored in the memory 250. Additionally, in some implementations, the processor 210 utilizes the network interface 220 to communicate with the network service 120 (see FIG. 1). More specifically, the e-reading device 110 can access the network service 120 to receive various kinds of resources (e.g., digital content items such as e-books, configuration files, account information), as well as to provide information (e.g., user account information, service requests etc.). For example, e-reading device 110 can receive application resources 221, such as e-books or media files, that the user elects to purchase or otherwise download via the network service 120. The application resources 221 that are downloaded onto the e-reading device 110 can be stored in the memory 250.

In some implementations, the display 116 can correspond to, for example, a liquid crystal display (LCD) or light emitting diode (LED) display that illuminates in order to provide content generated from processor 210. In some implementations, the display 116 can be touch-sensitive. For example, in some embodiments, one or more of the touch sensor components 138 may be integrated with the display 116. In other embodiments, the touch sensor components 138 may be provided (e.g., as a layer) above or below the display 116 such that individual touch sensor components 116 track different regions of the display 116. Further, in some variations, the display 116 can correspond to an electronic paper type display, which mimics conventional paper in the manner in which content is displayed. Examples of such display technologies include electrophoretic displays, electrowetting displays, and electrofluidic displays.

The processor 210 can receive input from various sources, including the touch sensor components 138, the display 116, and/or other input mechanisms (e.g., buttons, keyboard, mouse, microphone, etc.). With reference to examples described herein, the processor 210 can respond to input 231 detected at the touch sensor components 138. In some embodiments, the processor 210 responds to inputs 231 from the touch sensor components 138 in order to facilitate or enhance e-book activities such as generating e-book content on the display 116, performing page transitions of the displayed e-book content, powering off the device 110 and/or display 116, activating a screen saver, launching or closing an application, and/or otherwise altering a state of the display 116.

In some embodiments, the memory 250 may store display sensor logic 135 that monitors for user interactions detected through the touch sensor components 138, and further processes the user interactions as a particular input or type of input. In an alternative embodiment, the display sensor logic 135 may be integrated with the touch sensor components 138. For example, the touch sensor components 138 can be provided as a modular component that includes integrated circuits or other hardware logic, and such resources can provide some or all of the display sensor logic 135. In variations, some or all of the display sensor logic 135 may be implemented with the processor 210 (which utilizes instructions stored in the memory 250), or with an alternative processing resource.

For some embodiments, the display sensor logic 135 may detect the presence of water and/or other extraneous objects, including debris and dirt, on the surface of the display 116. For example, the display sensor logic 135 may determine that extraneous objects are present on the surface of the display 116 based on a number of touch-based interactions detected via the touch sensors 138 and/or a contact duration (e.g., a length of time for which contact is maintained with a corresponding touch sensor 138) associated with each interaction. More specifically, the display sensor logic 135 may detect the presence of water and/or other extraneous objects if a detected interaction falls outside a set of known gestures (e.g., gestures that are recognized by the e-reading device 110). Such embodiments are discussed in greater detail, for example, in co-pending U.S. patent application Ser. No. 14/498,661, titled “Method and System for Sensing Water, Debris or Other Extraneous Objects on a Display Screen,” filed Sep. 26, 2014, which is hereby incorporated by reference in its entirety.

In one implementation, the display sensor logic 135 includes detection logic 213 and gesture logic 215. The detection logic 213 implements operations to monitor for the user contacting a surface of the display 116 coinciding with a placement of one or more touch sensor components 138. The gesture logic 215 detects and correlates a particular gesture (e.g., pinching, swiping, tapping, etc.) as a particular type of input or user action. The gesture logic 215 may also detect directionality so as to distinguish between, for example, leftward or rightward swipes.

For some embodiments, the display sensor logic 135 further includes splash mode (SM) logic 217 for adjusting one or more settings of the e-reading device 110 in response to detecting the presence of water and/or other extraneous objects on the surface of the display 116. For example, the splash mode logic 217 may configure the e-reading device 110 to operate in a “splash mode” when water and/or other extraneous objects are present (e.g., “splashed”) on the surface of the display 116. While operating in splash mode, one or more device configurations may be altered or reconfigured to enable the e-reading device 110 to be continuously operable even while water and/or other extraneous objects are present on the surface of the display 116. More specifically, the splash mode logic 217 may perform one or more operations to mitigate or overcome the presence of extraneous objects (e.g., such as water) on the surface of the display 116. Accordingly, the splash mode logic 217 may be activated by the display sensor logic 135 upon detecting the presence of extraneous objects on the surface of the display 116.

For some embodiments, the splash mode logic 217 may reconfigure one or more actions (e.g., input responses) that are to be performed by the e-reading device 110 in response to user inputs. For example, the splash mode logic 217 may disable or dissociate certain actions (e.g., such as performing multi-page and/or chapter transitions) that are triggered by user touch interactions (e.g., requiring concurrent contact at multiple distinct locations on the display 116) and/or persistent user interactions (e.g., requiring continuous contact with the touch sensors 138 over a given duration) because such interactions could be misinterpreted by the gesture logic 215 given the presence of extraneous objects on the surface of the display 116. The disabling or dissociation may be accomplished by terminating electrical power selectively to those components implicated in a portion of circuitry, using interrupt-based logic to selectively disable the components involved, such as touch sensors 138 disposed in association with display screen 116.

Additionally, and/or alternatively, the splash mode logic 217 may enable a new set of actions to be performed by the e-reading device 110. For example, the splash mode logic 217 may remap, or associate, one or more user input commands to a new set of motion actions as detected by motion sensor(s) 136. With motion sensor(s) activated for use in conjunction with splash mode 217, a new set of actions (e.g., such as a tilt, a shake, a rotation, a swivel or partial rotation and an inversion of e-reading device 110 as detected via motion sensors 136 for interpretation as respective input commands by motion gesture logic 137) may be performed on the e-reading device 110 and be validated or recognized only when water and/or other extraneous objects are present on the surface of the display 116. More specifically, the new set of actions may enable the e-reading device 110 to operate in an optimized manner while the water and/or other extraneous objects are present.

### Methodology of Operating an Electronic Media Providing Device

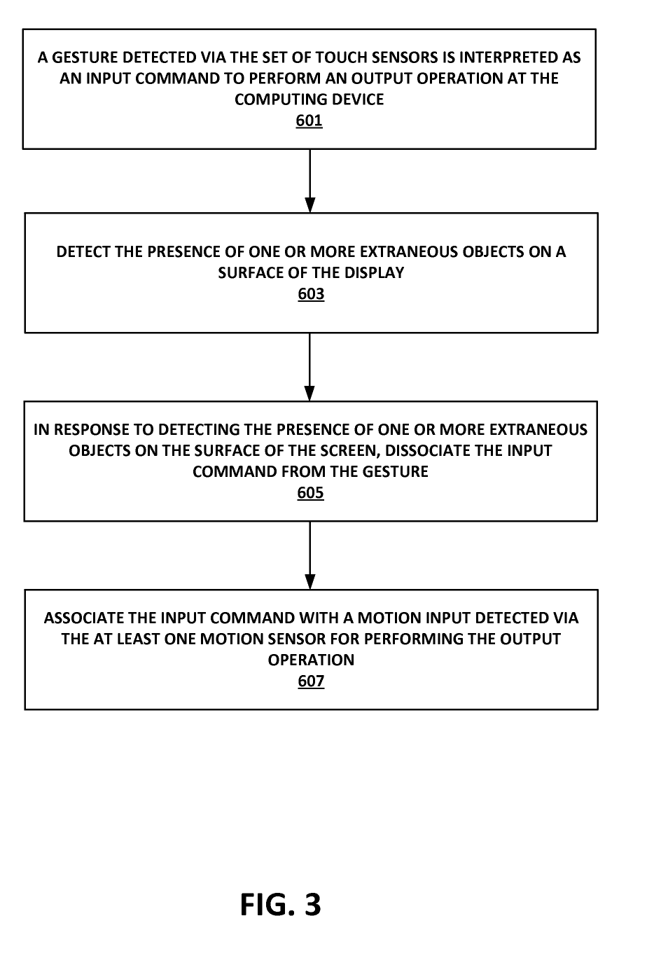

FIG. 3 illustrates a method of operating an electronic media providing device 400B, such as an e-reading device 110, when water and/or other extraneous objects are present on the display 116, according to one or more embodiments. In describing the example of FIG. 3, reference may be made to components such as described with FIGS. 1 and 2 for purposes of illustrating suitable components and logic modules for performing a step or sub-step being described.

With reference to the example of FIG. 3, at step 301 the e-reading device 110 may detect the presence of one or more extraneous objects on a surface of the display 116 (610). For some embodiments, the display sensor logic 135 may detect the presence of extraneous objects on the surface of the display 116 based on a number of touch-based interactions detected via the touch sensors 138 and/or a contact duration associated with each of the interactions. For example, the display sensor logic 135 may determine that extraneous objects are present on the surface of the display 116 if a detected interaction falls outside a set of known gestures.

At step 301, a gesture detected via the set of touch sensors is interpreted as an input command to perform an output operation at the computing device 110.

At step 303, splash mode logic 217 detects the presence of one or more extraneous objects on a surface of the display 116.

At step 305, the splash mode logic 217 may disable or dissociate certain user input commands associated with touch gestures such as a tap, a sustained touch, a swipe or some combination thereof, received at display screen 116 as detected via touch sensors 138.

At step 307, splash mode logic 217 in conjunction with motion gesture logic 137 then reconfigures or remaps the set of user input commands by associating ones of the set with respective motion input commands as detected via motion sensors 136. Example motions may include a tilt, a shake, a rotation, a swivel or partial rotation an inversion, or some combination thereof, of e-reading device 110 as detected via motion sensors 136 and interpreted by motion gesture logic 137 to accomplish respective output operations for e-reading actions, such as turning a page (whether advancing or backwards), placing a bookmark on a given page or page portion, placing the e-reader device in a sleep state, a power-on state or a power-off state, and navigating from the e-book being read to access and display an e-library collection of e-books that may be associated with user account store 124.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments.

### System for Providing a Scent while a User is Interacting with an Electronic Media Providing Device

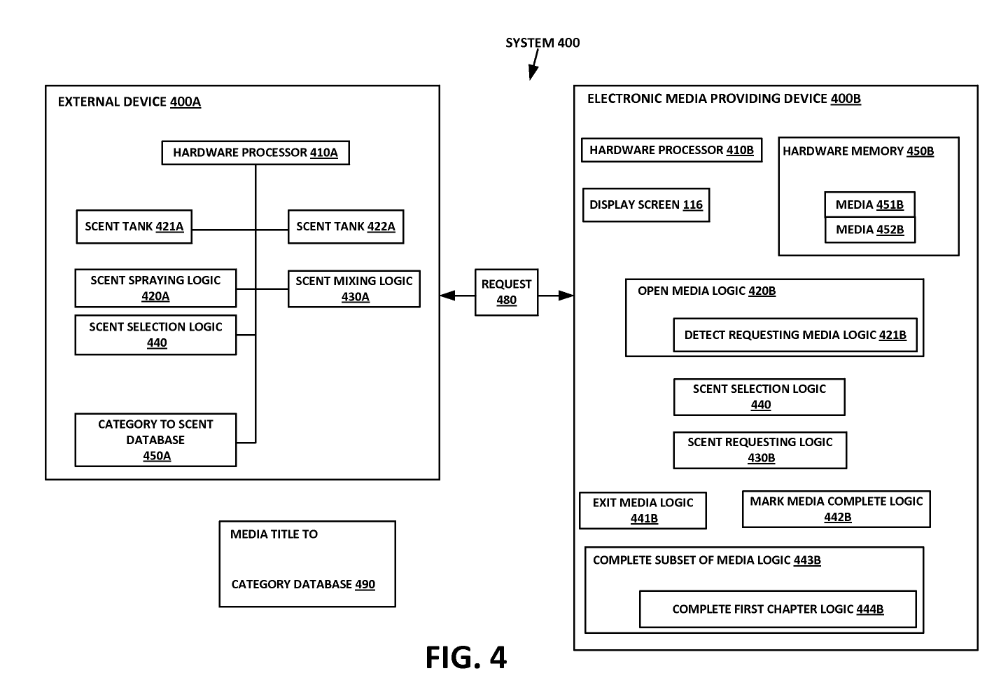

FIG. 4 depicts a block diagram of a system 400 for providing a scent while a user interacts with an electronic media providing device 400B, according to one embodiment.

The blocks that represent features in FIG. 4 can be arranged differently than as illustrated, and can implement additional or fewer features than what are described herein. Further, the features represented by the blocks in FIG. 4 can be combined in various ways. The system 400 can be implemented using software, hardware, hardware and software, hardware and firmware, or a combination thereof. Further, unless specified otherwise, various embodiments that are described as being a part of the system 400, whether depicted as a part of the system 400 or not, can be implemented using software, hardware, hardware and software, hardware and firmware, or a combination thereof.

The system 400 includes an electronic media providing device 400B and an external device 400A.

The electronic media providing device 400B, according to one embodiment, includes hardware memory 450B, at least one electronic media 451B, 452B, open media logic 420B, detect requesting media logic 421B, scent requesting logic 430B, scent selection logic 440, exit media logic 441B, mark media complete logic 442B, complete subset of media logic 443B and complete first chapter logic 444B. The open media logic 420B includes the detect requesting media logic 421B. The complete subset of media logic 443B includes the complete first chapter logic 444B. The hardware memory 450B includes the electronic media 451B, 452B.

The external device 400A includes at least one scent tank 421A, 422A. As depicted the external device 400A includes a first scent tank 421A and a second scent tank 422A. The external device 400A further includes scent spraying logic 420A, scent selection logic 440, scent mixing logic 430A and a category to scent database 450A. The external device 400A can be a hardware scent device that includes the one or more scent tanks 421A, 422A, a cover for the electronic media providing device 400B or a dock for the electronic media providing device 400B.

FIG. 4 also depicts a request 480 communicated from the electronic media providing device 400B to the external device 400A. The request 480 is also referred to as a spray scent request that can include one or more of the title of the media, the category of the media, the name of the selected scent (also referred to as “scent name”), an identifier of the scent tank (also referred to as “scent tank identifier”) that contains the selected scent, the number of times that the scent is sprayed and the interval between sprays if the scent is sprayed more than once.

Instead of being a hardware scent device, the external device 400A can be a cover or dock that holds or controls a hardware scent device that includes the one or more scent tank 421A, 422As, the logics and the category to scent database 450A, or a combination thereof. Any one or more of the scent tank 421A, 422As, the logics, and the category to scent database 450A can be a part of a cover or dock or a hardware scent device that is part of or separate from the cover or dock.

The external device 400A, or the hardware scent device, or both can be controlled, for example, with Bluetooth (BT) standardized as IEEE 802.15.1 using short-wavelength UHF radio waves in the ISM band from 2.4 to 2.485 GHZ, Near Field Communication (NFC) at a frequency of 13.56 MHz using, for example, ISO/IEC 18092/ECMA-340 or ISO/IEC 21481/ECMA-352, or wired universal serial bus (USB) connection.

Scent selection logic 440 may reside on either the electronic media providing device 400B or the external device 400A or both.

The electronic media providing device 400B can communicate with a media title to category database 490, for example, over the Internet. The media title to category database 490 may be associated with a system provided by a company that sells electronic games, electronic books or both, such as Amazon or Barnes and Noble.

The electronic media providing device 400B, the external device 400A, or the hardware scent device, or a combination thereof, may each include one or more hardware processors 410A, 410B that execute, for example, instructions of the various logics 420A, 430A, 440, 420B, 420B, 421B, 430B, 441B, 442B, 443B, or 444B, or a combination thereof.

Although FIG. 4 depicts the category to scent database 450A as being part of the external device 400A, the category to scent database 450A could reside in other places, such as on the electronic media providing device 400B or outside of both the external device 400A and electronic media providing device 400B.

### Media Categories

Examples of media categories are romance, fiction, mystery, teen, kids, business, science fiction, comics, biographical, autobiographical, and non-fiction. As discussed herein, at least part of a media's title can be used to determine a category of the media. For example, if the title includes the word “love” the category of romance may be determined for the media.

Many companies that sell electronic media, such as electronic games, electronic books or both, have databases (also referred to herein as “media title to category database 490”) that associate a category with information about the media. For example, the media title to category database 490 can include information such as the title, the author, and the category of the book. At least a part of the book's title can be used to access the category of the book. A table could be used instead of a database.

### Category to Scent Association

Each category can be associated with one or more scents. For example, various fruit scents can be associated with the categories of romance and/or fiction. Further, each scent can provide a different sensation or feeling to the user.

More specifically, the following scents may be associated with either the romance category or the fiction category, or both.

Citrus blast, which is a mixture or orange, key lime and fresh lemon, provides an alert sensation.

Fresh cherry provides a sweet and strong sensation.

Grapefruit provides a crisp and tart sensation.

Green Apple provides a light, crispy and tangy sensation.

Melon provides a light, easy and mildly sweet sensation.

Orange provides a moderately citrus sensation.

Sunny delight provides a strong burst of citrus sensation and smells surprisingly like the beverage called sunny delight.

Strawberry provides a sweet and playful sensation.

Fresh lemon provides a strong, clean and bright sensation.

The following scents may be associated with the mystery category or the adventure category or both.

Gardenia which provides the sensation of a floral bouquet.

Mountain Air which has a fresh scent with a hint of mint and meadow with no floral tones.

Ocean Wave which has a clean, window-blown scent with a mix of beach and sea.

Rain which has a clean, soapy fragrance.

Wonderland Hills which is an earthy blend with a touch of sweetness.

### Method for Providing a Scent while a User is Interacting with an Electronic Media Providing Device

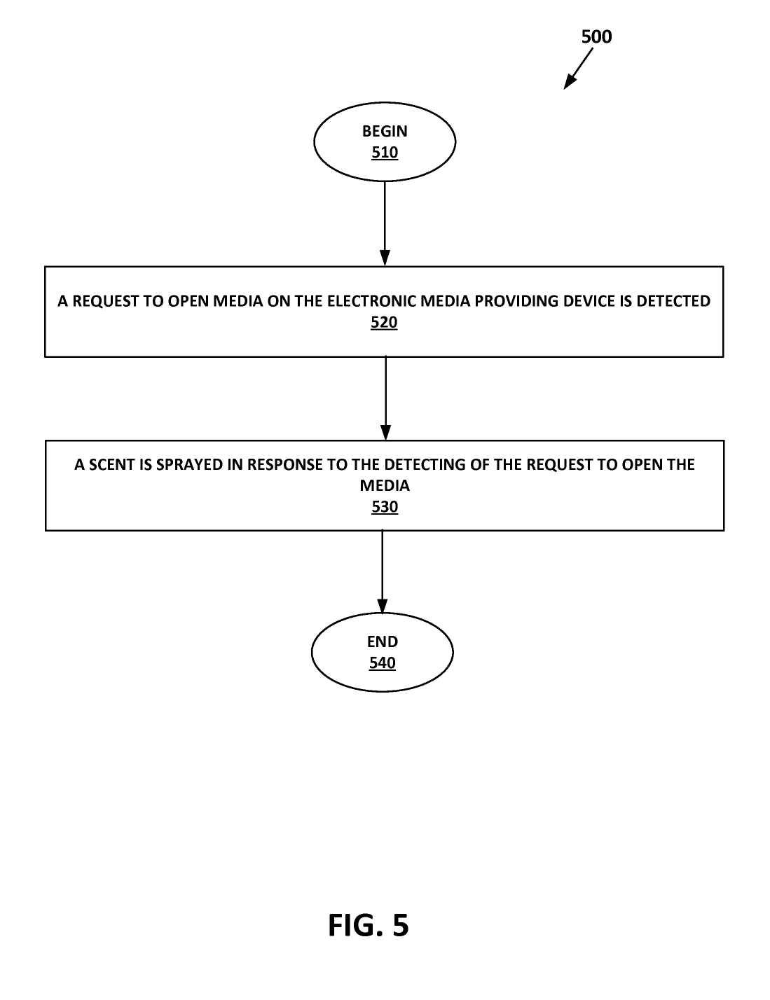

FIG. 5 depicts a flowchart 500 for a method of providing a scent while a user interacts with an electronic media providing device 400B, according to one embodiment.

Although specific operations are disclosed in flowchart 500, such operations are exemplary. That is, embodiments of the present invention are well suited to performing various other operations or variations of the operations recited in flowchart 500. It is appreciated that the operations in flowchart 500 may be performed in an order different than presented, and that not all of the operations in flowchart 500 may be performed.

The above illustration is only provided by way of example and not by way of limitation. There are other ways of performing the method described by flowchart 500.

Assume for the sake of illustration that the system 400 depicted in FIG. 4 performs the method depicted in flowchart 500.

At 510, the method begins.

At 520, a request to open media on the electronic media providing device 400B is detected.

For example, assume that the open media logic 420B of the electronic media providing device 400B is called in response to a user clicking on a visual representation of a media, such as an icon, displayed on the display screen 116 of the electronic media providing device 400B. The open media logic 420B calls the detect requesting media logic 421B. The electronic media providing device 400B may include display instead of display screen 116.

The scent requesting logic 430B transmits a request 480 (also referred to as “spray scent request”) to the scent spraying logic 420A on the external device 400A. The eternal device includes one or more scent tank 421A, 422As. The spray scent request 480 can include one or more of a scent name, a category, a title of the media, an identifier of a scent tank or a combination thereof.

At 530, a scent is sprayed in response to the detecting of the request to open the media.

In one embodiment, the scent spraying logic 420A can cause the scent to be sprayed, for example, by actuating a nozzle associated with the scent tank 421A, 422A. The scent that is sprayed may be a single scent, a customized scent, and mixture of a plurality of scents from a plurality of scent tanks 421A, 422A. The single scent may be a mass marked scent or a customized scent.

According to one embodiment, different types of scents are associated with different types or categories of media. For example, citrus blast is associated with the romance category and gardenia is associated with the mystery category, as discussed herein. The scent that is spayed in 530, can be determined based on a type of the media that is opened. More specifically, a media category can be associated with each of the scents. The category of the media can be determined, for example, based on at least a subset of the media's title. For example, if the title included the word “love” the category may be romance. In another example, a media title to category database 490 can be queried with the title or a subset of the title to determine the category.

The category of the media can be determined based on at least one word in a title of the media using a database 490 or without a database 490. The database 490 may be a legacy database. For example, many online book stores, such as Amazon or Barnes and Noble, have databases that categorize media. For example, the databases include information such as the title, the author, and the category of the book or game. At least a part of the media's title can be used to access the category of the media. A table could be used instead of a database.

The scent can be selected from a plurality of scents based on the determined category, according to one embodiment. For example, if the category is romance, the citrus blast scent may be selected. Scent selection logic 440 can select the scent based on the determined category. The scent selection logic 440 can access the category scent database 450A with the category to obtain the name of the scent to be sprayed. The scent selection logic 440 can reside on either the electronic media providing device 400B or the external device 400A. The scent spraying logic 420A can use the scent name to determine which scent tank 421A, 422A to spray the sent from.

Alternatively, an identifier of the scent tank 421A, 422A can be used instead of the scent name. For example, the category to scent database 450A could associate a scent tank identifier with each of the categories. Then the scent spraying logic 420A can use the scent tank identifier to determine which scent tank 421A, 422A to actuate causing the scent tank 421A, 422A to spray.

The scent spraying logic 420A can spray the scent sprayed repeatedly until an event occurs. Examples of an event include exiting the media, marking the media as complete, completing a first chapter of the media, and completing a subset of the media. Exit media logic 441B, mark media complete logic 442B, complete first chapter logic 444B and complete subset of media logic 443B respectively can provide determining that the media has been exited, the media has been marked complete, a first chapter of the media has been completed, and a subset of the media has been completed.

According to one embodiment, a predetermined amount of time can elapse between each time that the scent is sprayed. An example of a predetermined amount of time is an hour. However, embodiments are well suited to other predetermined amounts of time, such as a minute, a 5 minutes, or a couple of hours. The amount of time between each spray can be a default value, a user specified value or a configured value.

According to one embodiment, the external device 400A includes a plurality of scent tanks with each scent tank including a different scent. For example, assume that the external device 400A includes four scent tanks with respective four scents that are different from each other. The scent mixing logic 430A can select, for example, a first scent and a second scent from the different scents and communicate the first scent and the second scent to the scent spraying logic 420A. The first scent and the second scent can be selected for example, based on the category of the media, as described herein. The scent spraying logic 420A sprays the first scent and the second scent together, for example, as a mixture in response to the detecting of the request to open the media performed at 520.

At 540, the method ends.

### Computer Readable Medium

Unless otherwise specified, any one or more of the embodiments described herein can be implemented using non-transitory computer readable storage medium and computer readable instructions which reside, for example, in computer-readable storage medium of a computer system or like device. The non-transitory computer readable storage medium can be any kind of physical memory that instructions can be stored on. Examples of the non-transitory computer readable storage medium include but are not limited to a disk, a compact disk (CD), a digital versatile device (DVD), read only memory (ROM), flash, and so on. As described above, certain processes and operations of various embodiments of the present invention are realized, in one embodiment, as a series of computer readable instructions (e.g., software program) that reside within non-transitory computer readable storage memory of a computer system and are executed by the hardware processor of the computer system. When executed, the instructions cause a computer system to implement the functionality of various embodiments of the present invention. For example, the instructions can be executed by a central processing unit associated with the computer system. According to one embodiment, the non-transitory computer readable storage medium is tangible. The non-transitory computer readable storage medium is hardware memory.

Unless otherwise specified, one or more of the various embodiments described in the context of FIGS. 1-5 can be implemented as hardware, such as circuitry, firmware, or computer readable instructions that are stored on non-transitory computer readable storage medium. The computer readable instructions of the various embodiments described in the context of FIGS. 1-5 can be executed by a hardware processor, such as central processing unit, to cause a computer system to implement the functionality of various embodiments. For example, according to one embodiment, the logics depicted in FIG. 4 and FIG. 5 and the operations of the flowcharts depicted in FIG. 3 and FIG. 5 are implemented with computer readable instructions that are stored on computer readable storage medium that can be tangible or non-transitory or a combination thereof.

### CONCLUSION

Example embodiments of the subject matter are thus described. Although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

Various embodiments have been described in various combinations and illustrations. However, any two or more embodiments or features may be combined. For example, mixing of the scents can be used in combination with spraying the mixture of scents a predefined interval of time. In another example, the external device may include a cover or a dock where the cover or dock is attached to a hardware scent device that includes one or more scent tanks. The cover or dock may control the hardware scent device. Alternatively, the hardware scent device may control itself. Further, any embodiment or feature may be used separately from any other embodiment or feature. Phrases, such as “an embodiment,” “one embodiment,” among others, used herein, are not necessarily referring to the same embodiment. Features, structures, or characteristics of any embodiment may be combined in any suitable manner with one or more other features, structures, or characteristics.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Although some embodiments have been described in a language specific to structural features and/or methodological acts, it is to be understood that the subject matter defined in the appended claims is not necessarily limited to the specific features or acts described above. Rather, the specific features and acts described above are disclosed by way of illustration and as example forms of implementing the claims and their equivalents.

What is claimed is:

1. A method of providing a scent while a user interacts with an electronic media providing device, the method comprising:
detecting a request to open electronic media on the electronic media providing device; and
spraying a scent in response to the detecting of the request to open the electronic media.

2. The method of claim 1, wherein the media is selected from a group consisting of an electronic book and an electronic game.

3. The method of claim 1, wherein the method further comprises:
associating different types of scents with different types of media; and
determining the scent from a plurality of scents based on a type of the media that is opened.

4. The method as recited by claim 3, wherein the method further comprises:
associating different categories of media with each of the scents;
determining a category of the media; and
selecting the scent from the plurality of scents based on the category.

5. The method as recited by claim 4, wherein the method further comprises:
determining the category of the media based on at least one word in a title of the media.

6. The method as recited by claim 1, wherein the method further comprises:
repeatedly spraying the scent until an event occurs, wherein the event is selected from a group consisting of exiting the media, marking the media as complete, completing a first chapter of the media, and completing a subset of the media.

7. A system of providing a scent while a user interacts with an electronic media providing device, the system comprising:
detect requesting media logic that detects a request to open electronic media on the electronic media providing device;
an external device with a scent tank; and
scent spraying logic that sprays a scent from the scent tank in response to the detecting of the request to open the media.

8. The system of claim 7, wherein the system further comprises:
a plurality of scent tanks each with a different scent of a plurality of scents, wherein the scent tank is one of the plurality of scent tanks and the scent is one of the plurality of scents; and
scent selection logic that selects the scent based on a category associated with the media.

9. The system of claim 7, wherein the scent is a first scent and the scent tank is a first scent tank and wherein the system further comprises:
a plurality of different scent tanks that includes the first scent tank and a second scent tank with a second scent, wherein scents in each of the different scent tanks are different from each other;
scent mixing logic that selects the first scent and a second scent from the different scents and communicates the first scent and the second scent to the scent spraying logic; and
the scent spraying logic sprays the first scent and the second scent in response to the detecting of the request to open the media.

10. The system of claim 7, wherein the detect requesting media logic resides at the electronic media providing device.

11. The system of claim 7, wherein the system further comprises scent requesting logic that communicates a request for the scent to the scent spraying logic, wherein the scent requesting logic is part of the electronic media providing device and the scent spraying logic is part of the external device.

12. The system of claim 7, wherein the external device is selected from a group consisting of a cover, a dock and a scent device.

13. A non-transitory computer-readable storage medium storing instructions that, when executed by a hardware processor of a computing device, cause the hardware processor to perform operations that include:
detecting a request to open electronic media on the electronic media providing device; and
in response to the detecting of the request to open the electronic media, communicating a spray scent request to an external device that is external to the electronic media providing device.

14. The non-transitory computer-readable storage medium of claim 13, wherein the media is selected from a group consisting of an electronic book and an electronic game.

15. The non-transitory computer-readable storage medium of claim 13, wherein the operations further comprises:
associating different types of scents with different types of media; and
determining the scent from a plurality of scents based on a type of the media that is opened.

16. The non-transitory computer-readable storage medium as recited by claim 15, wherein the operations further comprises:
associating different categories of media with each of the scents;
determining a category of the media; and
selecting the scent from the plurality of scents based on the category.

17. The non-transitory computer-readable storage medium as recited by claim 16, wherein the operations further comprises:
determining the category of the media based on at least one word in a title of the media.

18. The non-transitory computer-readable storage medium as recited by claim 13, wherein the operations further comprises:
repeatedly spraying the scent until an event occurs, wherein the event is selected from a group consisting of exiting the media, marking the media as complete, completing a first chapter of the media, and completing a subset of the media.

19. The non-transitory computer-readable storage medium as recited by claim 13, wherein the external device is selected from a group consisting of a cover, a dock and a scent device.

20. The non-transitory computer-readable storage medium as recited by claim 13, wherein the scent is selected from a group consisting of a single scent, a customized scent, and mixture of a plurality of scents.
